(19) United States
(12) Patent Application Publication
(10) Pub. No.: US 2014/0236626 A1
(43) Pub. Date: Aug. 21, 2014

(54) SYSTEM AND METHOD FOR REMOTELY ADDRESSING MEDICAL REQUESTS

(71) Applicant: Bharath B. Reddy Bynagari, Carmel, IN (US)

(72) Inventor: Bharath B. Reddy Bynagari, Carmel, IN (US)

(73) Assignee: DIAGNOtes, INC., Indianapolis, IN (US)

(21) Appl. No.: 14/114,299

(22) PCT Filed: Apr. 30, 2012
(86) PCT No.: PCT/US12/35879

§ 371 Date: Jan. 27, 2014

Related U.S. Application Data
(60) Provisional application No. 61/480,943, filed on Apr. 29, 2011.

(51) Int. Cl. G06F 19/00

(52) U.S. Cl. CPC G06F 19/3418
USPC 705/3

(57) ABSTRACT

A system and method of remotely addressing medical requests is disclosed. Such a method includes receiving a medical request from a user at a processor, determining at least one health care provider that is appropriate for receiving the medical request from the user using the processor, and sending a notification to at least one mobile device of the at least one health care provider comprising a graphical user interface regarding the medical request. The method also includes receiving an access request from the at least one mobile device and sending data from the processor to the at least one mobile device, wherein the data comprises at least a portion of the medical request and at least a portion of a medical record.

### CROSS REFERENCE TO RELATED APPLICATION

This application claims the benefit of and incorporates by reference herein the disclosure of U.S. Ser. No. 61/480,943, filed Apr. 29, 2011.

### BACKGROUND

In the medical care profession, physicians play a central role in the care provided to a patient. In particular, physicians often make the big decisions regarding a patient's diagnosis, treatment, and the like. Therefore, it comes as no surprise that patients and medical care professionals that function under the direction of physicians often demand the attention of physicians at all times of the day. Generally, when physicians are not in their medical office, at the hospital, or otherwise readily available to provide their services, patients and medical personnel are still able to contact a physician through an after-hours or on-call service. Up until now, such services have involved allowing a patient or medical personnel to leave a simple voice message or text message. However, these services fail to provide the physician with the ability to consult the patient's medical information and take appropriate action without the physician being inconvenienced, such as having to pay a visit to the hospital or medical office. Accordingly, there exists a need to provide a physician or other health care provider with the ability to effectively and conveniently address medical requests while removed from their medical office, hospital, and the like.

### SUMMARY

The present disclosure discloses a system and method for remotely addressing medical requests. One embodiment of a method of remotely addressing medical requests includes receiving a medical request from a user at a processor, determining at least one health care provider that is appropriate for receiving the medical request from the user using the processor, and sending a notification to at least one mobile device of the at least one health care provider comprising a graphical user interface regarding the medical request. The method also includes receiving an access request from the at least one mobile device and sending data from the processor to the at least one mobile device, wherein the data comprises at least a portion of the medical request and at least a portion of a medical record.

Another embodiment of a method of remotely addressing medical requests includes sending a notification to at least one mobile device of at least one health care provider comprising a graphical user interface regarding a medical request, displaying the notification via the graphical user interface, and receiving an access request from the at least one mobile device at the processor. The method also includes sending data from the processor to the at least one mobile device, wherein the data comprises at least a portion of the medical request and at least a portion of a medical record and displaying the data via the graphical user interface.

One embodiment of a system for remotely addressing medical requests includes a processor and a memory device electrically coupled to the processor. The memory device having stored therein a plurality of instructions which, when executed by the processor, cause the processor to do the following; send a notification to at least one mobile device of at least one health care provider comprising a graphical user interface regarding a medical request received from a user, wherein the processor determined that the at least one health care provider was appropriate for receiving the medical request and after the processor receives an access request from the at least one mobile device, send data from the processor to the at least one mobile device, wherein the data comprises at least a portion of the medical request and at least a portion of a medical record.

### BRIEF DESCRIPTION OF THE DRAWINGS

The features and advantages of this disclosure, and the manner of attaining them, will be more apparent and better understood by reference to the following descriptions of the disclosed method and computer-readable program, taken in conjunction with the accompanying drawings, wherein;

FIG. 1 is a diagrammatic view of a system suitable for implementing at least one embodiment of the present disclosure.

FIG. 2a is a flowchart showing one set of the steps suitable for being performed in receiving, handling, and forwarding a medical request according to at least one embodiment of the present disclosure.

FIG. 2b is a flowchart showing an exemplary method according to one embodiment of the present disclosure.

FIG. 2c is a flowchart showing an exemplary method according to one embodiment of the present disclosure.

FIG. 3 is a representative screenshot of the mobile application, which illustrates the receipt of a new call instance notification according to at least one embodiment of the present disclosure.

FIG. 4 is a representative screenshot of the mobile application, which illustrates the login screen according to at least one embodiment of the present disclosure.

FIG. 5 is a representative screenshot of the mobile application, which illustrates the Patient ID screen associated with a call instance.

FIG. 6 is a representative screenshot of the mobile application, which illustrates the Complaint screen associated with a call instance according to at least one embodiment of the present disclosure.

FIG. 7 is a representative screenshot of the mobile application, which illustrates the Complaint screen associated with an in-progress call instance including an ActiveConnect countdown according to at least one embodiment of the present disclosure.

FIG. 8 is a representative screenshot of the mobile application, which illustrates the Complaint screen associated with a completed call instance including a patient call back button according to at least one embodiment of the present disclosure.

FIG. 9 is a representative screenshot of the mobile application, which illustrates the screen displayed while the service is connecting the health care provider to the patient according to at least one embodiment of the present disclosure.

FIG. 10 is a representative screenshot of the mobile application, which illustrates patient interaction and documentation screen according to at least one embodiment of the present disclosure.

FIG. 11 is a representative screenshot of the mobile application, which illustrates the past call instance listing screen according to at least one embodiment of the present disclosure.

FIG. 12 is a representative screenshot of the mobile application, which illustrates the receipt of a new call instance notification during handling of another call instance according to at least one embodiment of the present disclosure.

FIG. 13 is a representative screenshot of the mobile application, which illustrates the patient record search screen according to at least one embodiment of the present disclosure.

FIG. 14 is a representative screenshot of the mobile application, which illustrates the statistics screen according to at least one embodiment of the present disclosure.

FIG. 15 is a representative screenshot of the mobile application, which illustrates the health care provider's calendar display screen according to at least one embodiment of the present disclosure.

FIG. 16 is a representative screenshot of the mobile application, which illustrates the login screen according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A system and method for remotely addressing medical requests is disclosed. The system and method of the present disclosure allows a medical request to be addressed in a manner that provides improved information access to health care providers and streamlines documentation of the transaction. As a result, patients are able to obtain medical advice from health care providers more efficiently, while health care providers are able to provide better advice because they are able to review each patient's pertinent medical history, as well as properly document the interaction within their records for subsequent use. Such documentation can be useful for a variety of reasons, including shielding against malpractice liability and obtaining proper compensation for the consultation.

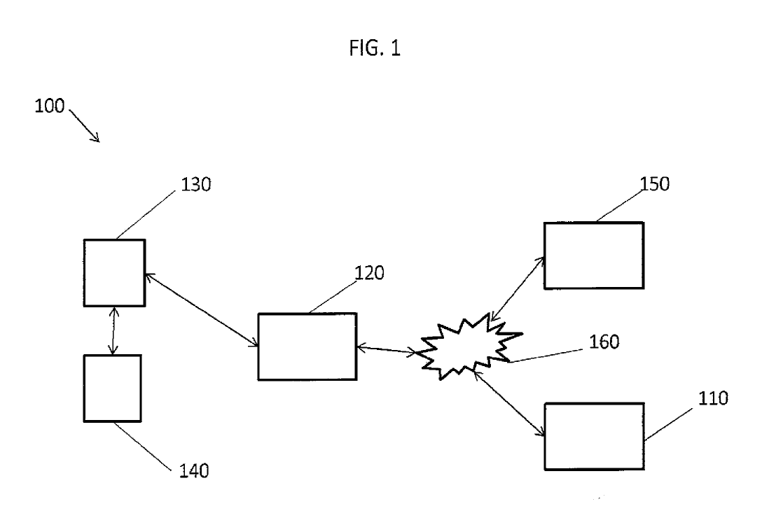

Turning to FIG. 1, an exemplary system 100 according to one embodiment of the present disclosure is illustrated. As described herein, various entities may use the system of the present disclosure. For example, a medical facility, a health care provider, or a patient may use the system. It should be appreciated that “patient,” as generally used herein, may refer to the actual patient, the patient's parent, family member, representative, guardian caregiver, nurse, primary health care provider, or the like. As shown in FIG. 1, a patient may interface with the system 100 using a patient device 110, which in the embodiment illustrated is a telephone (including land based, mobile, and VoIP) or similar device, by dialing a provided telephone number. The telephone number dialed by the patient may be the same as that of a medical facility. The telephone call from the patient device 110 may be subsequently forwarded to a call center 120 during the times when the medical facility is closed but may also be forwarded when the medical facility is open, or the medical facility may provide a separate health care provider assistance telephone number to its patients which is directly answered by the call center 120.

As shown in FIG. 1, the system 100 includes a computerized or human staffed answering service, referred to as a call center 120, that can determine whether the calling party is a patient, a patient's representative, medical personnel, or the like. The call center 120 may be a traditional call center which, in one form, is staffed by a number of operators and is capable of handling calls placed to a variety of different numbers or forwarded from various locations. For example, when a call comes into a call center 120 with human agents, an interactive window may pop up in the agent's computer screen. The interactive window may allow the agent to perform a variety of operations involving the patient, such as, for example, identify the patient, find the patient in the databases 140, collect or determine a callback phone number, and/or record the complaint of the patient. In another form, the call center 120 may be comprised at least partially of a virtual call center in that speech recognition is used in place of traditional human operators for at least a portion of the call processing. In any form, the call center 120 may be capable of utilizing a voice response unit (VRU), the dialed number identification service (DNIS), and caller identification (CID) to facilitate data collection and subsequent call processing.

The call center 120 may determine the identity of the caller by utilizing various servers 130 and databases 140, which may be remote from the call center 120 or part of the call center 120. If the calling party is not the patient, the call center 120 may be able to determine (such as by accessing various servers 130 and databases 140) what patient is represented by the calling party, such as by reviewing records indicating relationships between patients and other individuals and whether or not the other individuals have permission to call on behalf of a particular patient (all of which may be stored in databases 140). For example, the phone numbers of a patient's parents may be stored in databases 140 regarding the patient so that when one of the patient's parents calls the call center 120, the call center is able to determine that the incoming phone number is that of the patient's parent and verify that the parent has permission to provide a medical request for the patient. Similarly, after identifying the calling party (and corresponding patient, if applicable), the call center 120 determines the proper entity or health care provider that should receive the medical request information, such as the attending health care provider or on-call health care provider. This determination may be made by one of the human agents at the call center 120 who may choose, for example, a preferred health care provider, such as a physician within a particular health network. This determination may also be made automatically, such as, for example, by the processor accessing the databases 140 for on-call schedules or the like. It should be noted that the on-call schedule for health care providers may be maintained by a separate application or device (e.g., Diagnotes On-Call Manager (DOM)). The DOM app, for example, may be used by medical practice staff to maintain schedules, process calls by patients, maintain contact methods for all on-call health care providers and the like. Therefore, the system 100 may access or request schedule information from such a separate application. It should be noted that the choice of health care provider by the call center 120 may be based on a variety of factors, such as, for example, seniority, satisfaction score by patients, and the like. It should be further noted that the call center 120 may notify more than one health care provider for a particular patient or may notify health care providers in order of priority. For instance, a second health care provider may be notified if the first health care provider (who was previously notified) has not accessed the application on their mobile device or otherwise replied within a certain predetermined time (e.g., one hour).

After the calling party is identified, the calling party can provide medical request information (e.g., a chief complaint and a callback number) to the call center 120 using the patient device 110. The medical request information may be provided in various ways, such as, for example, a voice message, user selections in a series of prompts from the call center 120 (e.g., “if you have a fever, press 1; if you have a cough, press 2”), and the like. The medical request information may include all types of information that a patient desires to convey to his/her health care provider, such as, for example, a patient's symptoms and the like.

During and/or after medical request information is submitted by the patient, a notification is sent to the corresponding health care provider's mobile device 150. The mobile device 150 may be a variety of devices, such as, for example, a handheld smartphone, handheld computer, and the like. The notification to the proper health care provider's mobile device 150 may be of a new call currently being processed and allow the health care provider to interrupt or listen in, or the notification may be of a completed call. After the notification is provided, the health care provider is able to interact with an application on his/her mobile device 150, such as to selectively view the patient's biographical information, access a transcription or voice recording of his/her chief complaint, and/or access any portion of the patient's records from an EMR platform. The health care provider can also select a button provided in the application (or other feature of the application) to dial the patient at their provided call back number. Furthermore, the health care provider may dictate a summary of the interaction and their advice or instructions to be transcribed (or recorded) and included with the patient's EMR. Still further, the health care provider may be able to order a prescription for the patient and have it electronically delivered to the patient's pharmacy of choice. The health care provider can also forward the patient's details via secure e-mail to the health care provider's assistant or other individual or entity for either follow up or to make a new appointment or send a note to the patient's primary care health care provider or he/she can do any other follow up activities from the mobile application. It should be noted that the functionality provided at the mobile application to the health care provider may be available to an agent at the call center. For example, an agent at the call center may be able to forward patient's details via secure e-mail, forward medical advice to a pharmacy, and include medical advice/instructions in a patient's EMR.

The health care provider may interface with the system, and ultimately the patient, through a mobile application accessible via his/her user device 150. In the illustrated embodiment, the user device 150 is a smart phone or similar device having wireless connectivity to both voice and data networks. The mobile application may be a web based mobile application or a dedicated installable application for one of many common mobile operating systems, such as iOS, Blackberry OS, Android, Windows Phone 7, WebOS, Palm OS, Symbian, or the like. In one embodiment, the mobile application is installed upon the mobile device 150 of one or more health care providers, such as their Internet enabled smart phone. All aspects of the system of the present disclosure can be configured to meet the most stringent HIPAA guidelines and regulations for secure information storage and transfer, as well as any other relevant regulations regarding the transmission of such medical information.

As shown in FIG. 1, the exemplary system 100 also includes a transmission network 160 to connect the call center 120 and servers 130 (as well as databases 140) to the mobile devices 150 of the subscribing health care providers. The transmission network 160 provides telephony services as well as data flow back and forth between the call center 120 and the mobile applications on the mobile devices 150. Additionally, the call center 120 is accessible to any potential callers using patient devices 110 by the illustrated transmission network 160. The transmission network 160 may include a combination of any of the following: traditional PSTN lines, digital lines (such as T1, T3, OC3), or any other transmission medium suitable for carrying voice and/or data. It shall be appreciated that the transmission network 160 may include one or more wireless transmission links, such as a wireless or cellular network, including both voice and data transmission channels.

It should be noted that the databases 140 may include electronic medical records (EMR) databases of the subscribing medical facilities. The access to such databases may be provided by a private secure connection, such as a virtual private network (VPN), or the like, to maintain the confidentiality of the patient information contained by the EMR databases as required by applicable state, federal, and international laws, including HIPAA.

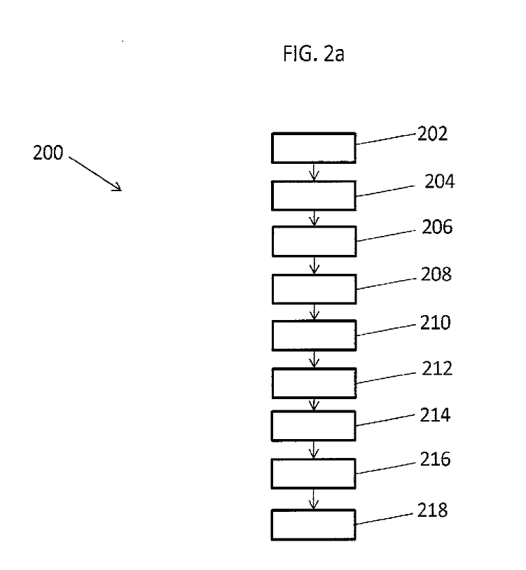

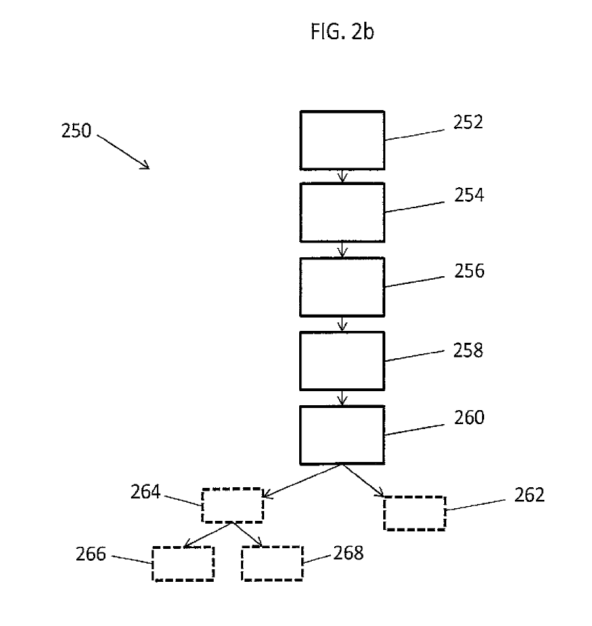

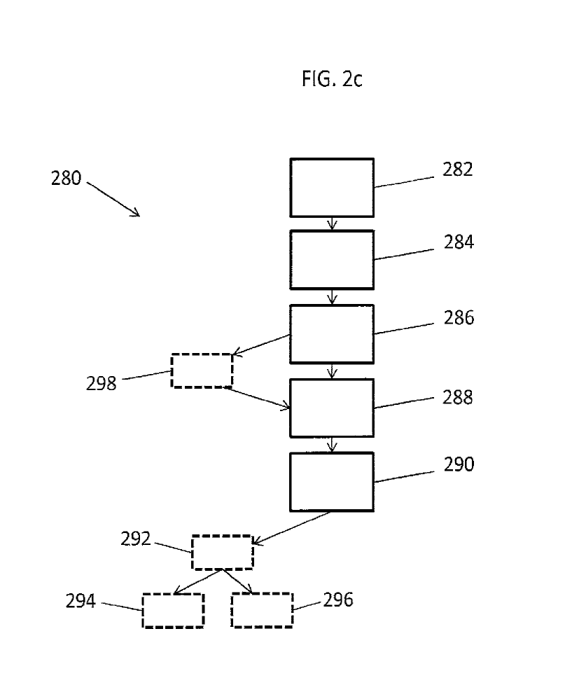

Turning to FIG. 2a, according to at least one embodiment, a method 200 of using the system of FIG. 1 is illustrated. The method 200 begins when a caller dials the number of a selected medical facility and is forwarded to the call center or reaches the call center directly 200. As noted above, a call center can include human agents that receive calls, electronic agents (e.g., automated, electronic system), or a combination of human and electronic agents. Also, the caller shall be referred to herein as the “patient”, but that the caller may also be the patient's parent, family member, representative, guardian caregiver, nurse, healthcare professional, or the like. Upon receiving the incoming call, the call center connects to the patient in a telecommunication session 204. Additionally, upon connection or shortly thereafter, the call center collects caller information based upon the call 206, which may include the number dialed by the patient via DNIS and the patient's telephone number via CID. In the event sufficient information cannot be collected, or to confirm such information, upon connection to the patient, the call center (e.g., Interactive Voice Response (IVR) system) may ask the patient for general information such as their name, identification number, last four digits of their social security number, birth year, health care provider name, best call back number, and the like. This information may be requested from the patient by a live human operator at the call center or collected using an interactive voice responder, as is known in the art.

Once the patient is identified, the system retrieves at least a portion of the electronic medical records associated with the identified patient 208 using the servers. The portion of the electronic medical records retrieved may be filtered in a customized way, in a way specified by each health care provider, or otherwise organized in a convenient manner. In one embodiment, only a portion of the electronic medical records retrieved are made available to the operator, if live, so that a confirmation of the proper record can be made while maintaining the patient's confidentiality.

In addition to the retrieval of the patient's EMR, once the general information concerning the patient is acquired, the system may identify the health care provider who is responsible for the patient, or whom the patient attempted to reach 210. This may be accomplished using any combination of the caller information, the general information, and the EMR. For example, the identified health care provider may be determined simply by the number dialed in the event of a single health care provider practice or by the health care provider name provided by the caller. Once the health care provider is identified, a notification is provided at any time to the application on the mobile device associated with the identified health care provider 212, such as by an in-app notification or SMS message. In one form, this notification is provided as soon as the health care provider is identified so that the health care provider may be offered the opportunity to break in and speak with the patient immediately by breaking into the call, as will be described later. In an alternate form, the notification may not be sent until all of the relevant information is collected from the patient, including that information described below. Such a notification serves to create an initial call instance in the mobile application of the health care provider. Each call instance is, at some point, associated with a patient and additional information, as will be described further herein.

Now that the patient has provided the requisite identifying information or the requisite identifying information has been otherwise determined, the system may begin pushing relevant information concerning the patient to the mobile application 214 for reference by the health care provider in association with the call instance. This relevant information may include portions of the patient's EMR, such as current and prior prescriptions, allergies, prior problems/procedures, previous observations, notes, diagnostic images, or the like. This information is organized and made available to the health care provider within the mobile application as will be illustrated later.

Once the patient has identified himself (and, optionally, if the health care provider has not interrupted the call to this point), the system requests specific information concerning his call 216 (e.g., a chief complaint and call-back number). In at least one embodiment, at least the patient's response is recorded and saved. In another form, the patient's response may alternatively or additionally be transcribed and provided to the mobile application on the device of the identified health care provider in associated with the previously established call instance. For example, a human agent at the call center may type a message representing the patient's medical request or an electronic agent at the call center may record the patient's medical request (e.g., electronic file). Once collected, the recording and/or transcript of the patient's chief complaint along with their call back number are forwarded to the health care provider's mobile application 218 for inclusion within the call instance.

At this point, the system has completed its collection of information and distribution of the information from the patient and can politely disconnect from the patient. Other than continuously serving and data transmission and/or data requests from the mobile application, the method 200 executed by the server can terminate.

Turning to FIG. 2b, an exemplary method 250 of remotely addressing medical requests is illustrated. In FIG. 2b, the method 250 includes the step of receiving a medical request from a user (e.g., patient) at a processor 252. As described above, the call center 120 may receive medical requests from users of patient devices 110. The method 250 also includes the step of determining at least one health care provider that is appropriate for receiving the medical request from the user using the processor 254. The at least one health care provider that is appropriate may be determined based on an on-call schedule, primary health care provider for the patient, and the like. The method 250 also includes the step of sending a notification to at least one mobile device of the at least one health care provider comprising a graphical user interface regarding the medical request 256. The notification may result in a display on the graphical user interlace that alerts the at least one health care provider. The method 250 also includes the step of receiving an access request from the at least one mobile device 258. The access request may include a username and password. As shown in FIG. 2b, the method 250 also includes sending data from the processor to the at least one mobile device 260, wherein the data comprises at least a portion of the medical request and at least a portion of a medical record. FIG. 2b shows that method 250 may optionally include displaying at least a portion of the data via the graphical user interface 262. FIG. 2b also shows that method 250 may optionally include after sending the data, receiving medical advice from the at least one health provider 264. FIG. 2b additionally shows that method 250 may optionally include sending the medical advice to one or more databases that store the medical records of the corresponding patient for storage in the same 266 and/or sending at least a portion of the medical advice (e.g., medication prescription) to a pharmacy 268.

Turning to FIG. 2c, an exemplary method 280 of remotely addressing medical requests is illustrated. The method 280 includes the step 282 of sending a notification to at least one mobile device of at least one health care provider comprising a graphical user interface regarding a medical request and the step 284 of displaying the notification via the graphical user interface. As described below, the notification may be displayed in a variety of ways on a user's mobile device. In FIG. 2c, the method 280 also includes the step 286 of receiving an access request from the at least one mobile device at the processor. The method 280 also includes the step 288 of sending data from the processor to the at least one mobile device, wherein the data comprises at least a portion of the medical request and at least a portion of a medical record, and the step 290 of displaying the data via the graphical user interface. As shown in FIG. 2c, the method 280 may optionally include the step 292 of receiving medical advice from the at least one health care provider at the processor. The method 280 may also optionally include the step 294 of sending the medical advice from the processor to one or more databases that store the medical record and/or the step 296 of sending a prescription to a pharmacy. As shown in FIG. 2c, the optional step 298 of transcribing a medical request is performed after step 286. It should be noted that step 298 may be performed before or after various other steps, such as, for example, before step 282.

The following description involves the health care provider's interaction with the mobile application through the course of a patient call instance. It shall be appreciated that the representative screenshots utilized herein are taken from an iOS implementation of the mobile application and are utilized to illustrate the described features, but are not intended to limit the functionality of the mobile application to only this one specific environment.

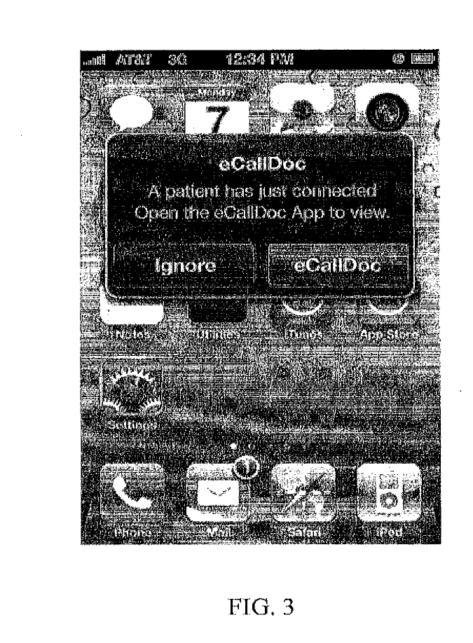

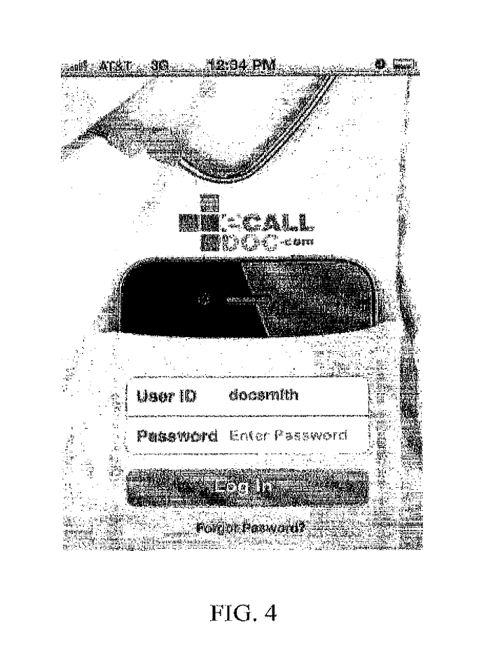

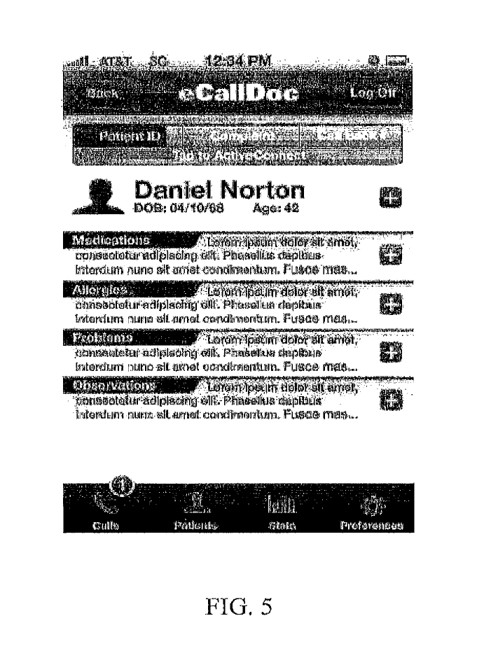

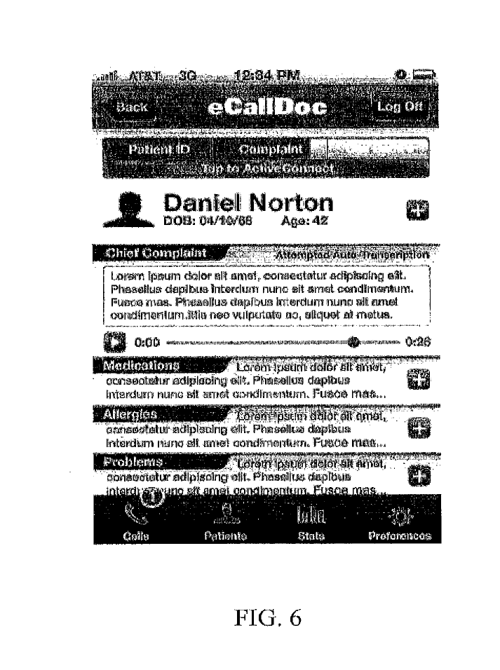

Shown in FIG. 3 is a representative screen shot of a notification triggered by the mobile application indicating that a new patient call instance has begun. The notification provides the health care provider with the ability to ignore the call instance or to open the mobile application and take action on the call instance, such as by tracking its progress or breaking in on the call. Turning to FIG. 4, a representative login screen of the mobile application is shown. In this form, the health care provider is required to enter a username and password before accessing the mobile application to ensure security and preserve confidentiality. Once logged in, the health care provider is prompted with a summary screen about the patient associated with the current or selected call instance, such as shown in FIG. 5. As can be seen, according to one form, the “Patient ID” screen includes information such as the patient's name, date of birth, age, medications, allergies, problems, and observations. Several of the categories of information may be expanded to provide additional detail. As will be appreciated, much of the information presented in the mobile application is derived from the patient's EMR which is accessed by the system and subsequently related to the mobile application. By using the navigation bar at the top of the mobile application, the health care provider can navigate to the “Complaint” screen shown in FIG. 6. The complaint screen includes a media player which, once transmitted, will allow the health care provider to listen to the patient's description of their complaint as an audio recording. Additionally, the screen may include an electronic or human transcription of the patient's chief complaint. As can also be seen, once the patient has been identified, a button appears in the mobile application entitled “Tap to ActiveConneet” which will allow the health care provider to break in on the telecommunication session between the system and patient. As can be seen, the navigation bar progressively fills from grey to blue to indicate the progress of the patient's call.

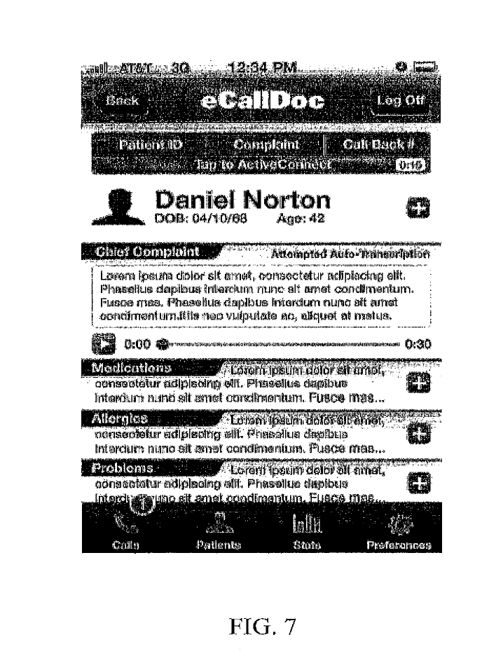

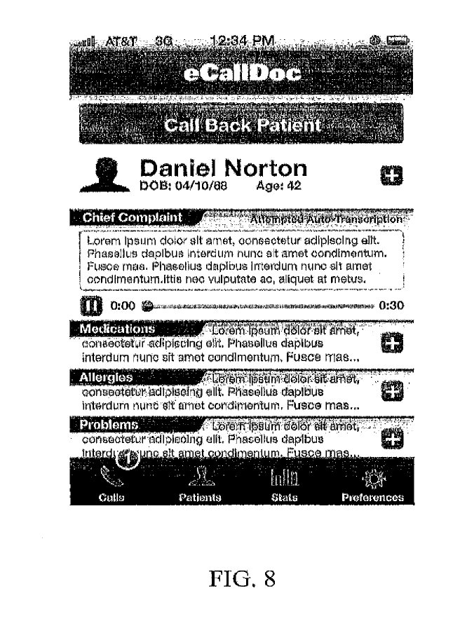

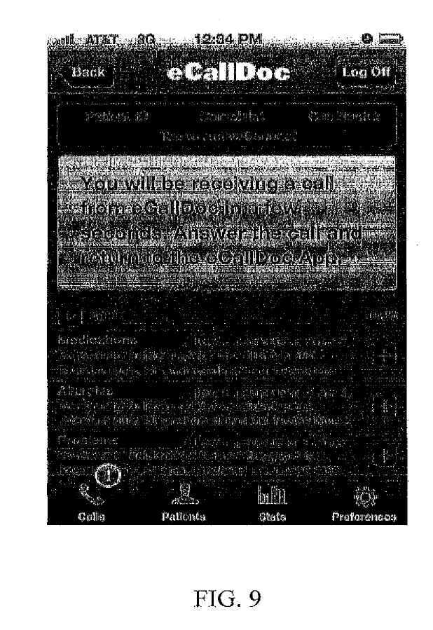

Turning to FIG. 7, once the system detects the call with the patient is projected to end, the mobile application will display a countdown in the upper right hand corner which indicated to the health care provider how long they likely have left in order to interrupt the call and be immediately able to speak with the patient. In the event the call with the patient is disconnected from the system without the health care provider interrupting, the screen shown in FIG. 8 is displayed and the health care provider may continue to interact with the information provided in the call instance. The health care provider may select the “Call Back Patient” button from the navigation bar to initiate a call to the patient's provided call back number. As a result of this action, the page shown in FIG. 9 is displayed to remind the health care provider to return to the mobile application upon entering the call with the patient. This is necessary due to the implementation if iOS, and may be handled differently in other environments.

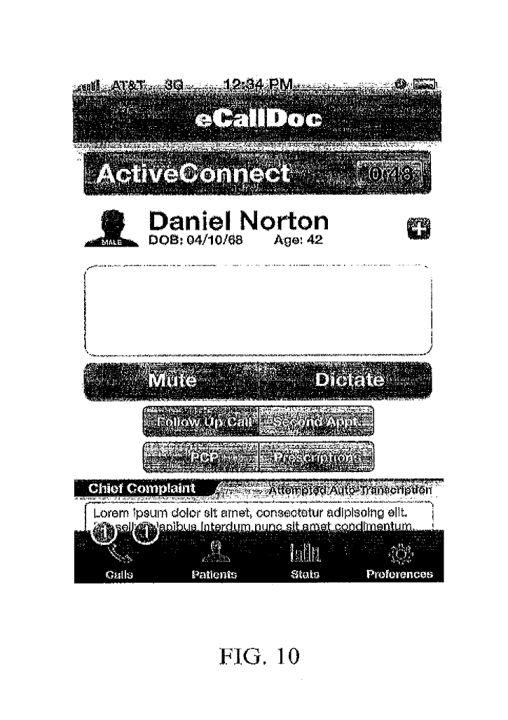

Once the health care provider is connected to the patient, either via their call back number or by interrupting their call with the system, the mobile application will display the activity page shown in FIG. 10. This page provides the same patient information, including relevant EMR information, as that of the previously described pages, but also includes buttons to mute the call, allows the health care provider to dictate notes or instructions, and handle other routine actions. Furthermore, every call made by the health care provider is logged fully. The time of call, the call duration, whether the call was transferred to the on-call health care provider, and the caller identity, complaint and callback number are all saved. As noted previously the complaint is available both as an audio recording, and as transcribed text, as well as the health care provider's recommendation or action taken with respect to each patient.

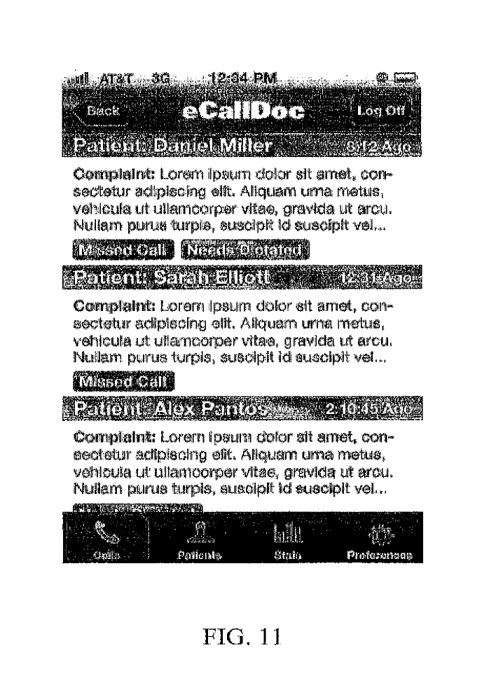

Turning away from the description of a single call instances, it shall be appreciated that in practice a health care provider cannot always be available to handle calls from patients. As such, the screen shown in FIG. 11 enables a health care provider to open the mobile application and view any call instances which were missed and/or have outstanding actions needed. The health care provider may review and handle each call instance in series or as desired from this screen just as was illustrated above with respect to FIGS. 3-10.

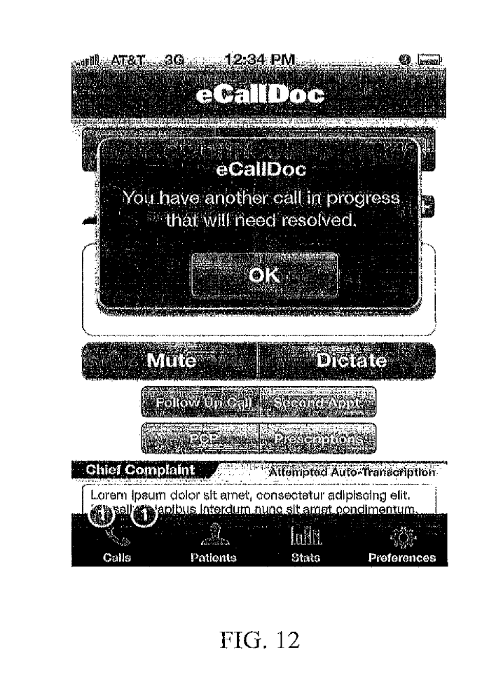

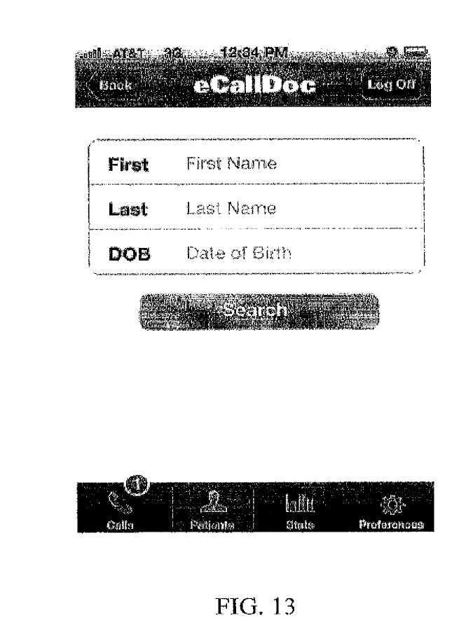

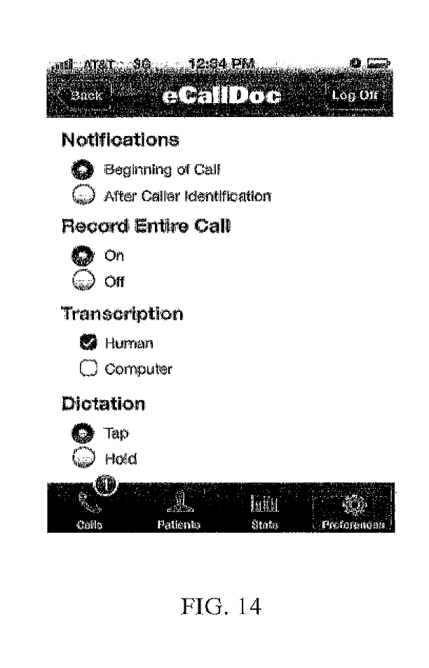

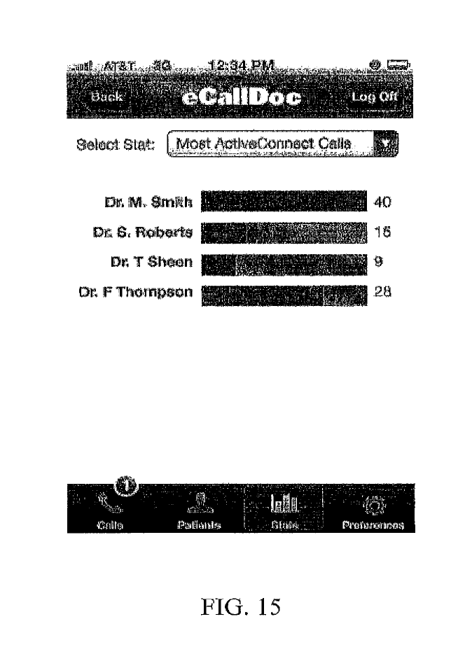

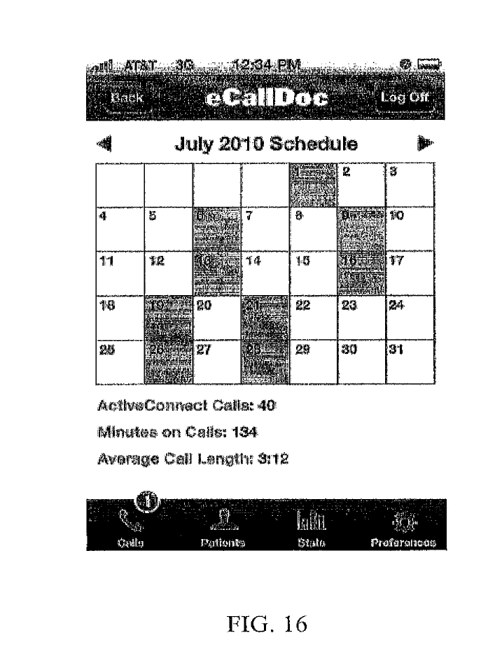

Additionally, notifications of other incoming calls may be generated during use of the mobile application as shown in FIG. 12. Furthermore, patient search functionality may be provided, as shown in FIG. 13, so that a health care provider may access the information associated with any of his/her patients at any time, or to correct an improperly identified patient in a call instance. Still further, FIGS. 14, 15, and 16 illustrate health care provider settings for how the mobile application will handle call instances, statistics concerning the health care providers' and potentially other's use of the mobile application, and the health care provider's schedule.

Furthermore, while not shown, it shall be appreciated that the system integrates the health care provider's response to the patient as carried out using the mobile application back into the patient's EMR as well as into the health care provider's systems, such as his/her billing and reporting system. For example, the system may generate an entry for a telephone consultation as well as generate a prescription refill request to a pharmacy in response to a health care provider's handling of a call instance.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

1. A method of remotely addressing medical requests comprising:
receiving a medical request from a user at a processor;
determining at least one health care provider that is appropriate for receiving the medical request from the user using the processor;
sending a notification to at least one mobile device of the at least one health care provider comprising a graphical user interface regarding the medical request;
receiving an access request from the at least one mobile device; and
sending data from the processor to the at least one mobile device, wherein the data comprises at least a portion of the medical request and at least a portion of a medical record.

2. The method of claim 1, further comprising displaying at least a portion of the data via the graphical user interface.

3. The method of claim 1, further comprising after sending the data, receiving medical advice from the at least one health care provider.

4. The method of claim 3, further comprising sending the medical advice to one or more databases that store the medical record.

5. The method of claim 3, further comprising sending at least a portion of the medical advice to a pharmacy.

6. The method of claim 1, wherein the step of receiving the medical request from the user comprises receiving a phone call.

7. The method of claim 1, wherein the step of determining the at least one health care provider is appropriate comprises determining the identity of the user.

8. The method of claim 7, wherein the data further comprises information regarding the user.

9. The method of claim 1, wherein the step of sending the notification to the at least one mobile device comprises sending an e-mail or sending a text message.

10. A method of remotely addressing medical requests comprising:
sending a notification to at least one mobile device of at least one health care provider comprising a graphical user interface regarding a medical request;
displaying the notification via the graphical user interface;
receiving an access request from the at least one mobile device at the processor;
sending data from the processor to the at least one mobile device, wherein the data comprises at least a portion of the medical request and at least a portion of a medical record; and
displaying the data via the graphical user interface.

11. The method of claim 10, further comprising receiving medical advice from the at least one health care provider at the processor.

12. The method of claim 11, further comprising sending the medical advice from the processor to one or more databases that store the medical record.

13. The method of claim 11, wherein the medical advice comprises a prescription.

14. The method of claim 13, further comprising sending the prescription to a pharmacy.

15. The method of claim 10, wherein the step of sending the notification comprises sending an e-mail or sending a text message.

16. The method of claim 10, wherein the medical request is a voice message.

17. The method of claim 16, further comprising transcribing the medical request.

18. A system for remotely addressing medical requests comprising:
a processor, and
a memory device electrically coupled to the processor, the memory device having stored therein a plurality of instructions which, when executed by the processor, cause the processor to:
(a) send a notification to at least one mobile device of at least one health care provider comprising a graphical user interface regarding a medical request received from a user, wherein the processor determined that the at least one health care provider was appropriate for receiving the medical request; and
(b) after the processor receives an access request from the at least one mobile device, send data from the processor to the at least one mobile device, wherein the data comprises at least a portion of the medical request and at least a portion of a medical record.

19. The system of claim 18, wherein when the plurality of instructions are executed the processor is further caused to display at least a portion of the data via the graphical user interface.

20. They system of claim 18, wherein when the plurality of instructions are executed the processor is further caused to send the medical advice to one or more databases that store the medical record.

21. A method for remotely addressing medical requests, the method comprising:
notifying a user, via an integrated application of a portable electronic device, to view a medical request;
receiving input from the user requesting the medical request;
providing the user with data comprising at least a portion of the medical request and at least a portion of a medical record associated with the medical request through the integrated application; and
providing the user with at least one response opportunity associated with the medical request through the integrated application.

22. The method of claim 21, wherein the step of providing the user with data comprises initiating a request to retrieve the at least a portion of the medical record.
